(19) United States
(12) Patent Application Publication
(10) Pub. No.: US 2010/0304658 A1
(43) Pub. Date: Dec. 2, 2010

(54) MOBILE LABORATORY FOR ANALYSIS OF PATHOGENIC AGENTS

(76) Inventor: Vladimir Grcevic, Brignoles (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/297,054

(22) PCT Filed: Apr. 16, 2007
(86) PCT No.: PCT/FR07/00638

§ 371 Date: Sep. 1, 2009

(30) Foreign Application Priority Data
Apr. 14, 2006 (FR) 0603352
Apr. 14, 2007 (FR) PCTFR2007000632

(51) Int. Cl. B01L 1/02

(52) U.S. Cl. 454/187

(57) ABSTRACT

This invention relates to a mobile laboratory for analysis of pathogenic agents. According to the invention, the laboratory (1) consists of a transportable mobile container defining a basic chamber (10), the space inside said chamber being isolated from the outside by means of a sealed box (5) inserted in said room, said box comprising a sealed zone for analysis of pathogenic agents (50d, 500d) fitted with a pressure device that maintains a negative pressure inside said zone relative to its external environment, characterised in that the sealed box (5) includes a first protective equipment airlock (500a), - a second sealed airlock (500b) communicating between said sealed zone for the analysis of pathogenic agents and said first airlock, a third sealed airlock (500c) communicating between said sealed zone for the analysis of pathogenic agents and said first airlock, wherein the zone for analysing pathogenic agents (500d) can only be entered through said second airlock.

An object of the present invention is a mobile laboratory for analysis of pathogenic agents.

It relates to the technical field of mobile laboratories rapidly transportable to a contaminated site for detection and rapid identification of pathogenic agents.

It relates, more particularly, to mobile analysis laboratories with high-security containment for the handling of radiological, chemical, or biological agents, highly pathogenic to the individual and to the community.

Contamination of individuals and communities by toxic, contaminant, or pathogenic agents is a very real risk.

In fact, major industrial accidents involving harmful substances have already taken place: AZF factory (France, 2001), Jiln factory (China, 2005), etc.

Likewise, terrorist attacks can take various forms and sometimes toxic chemicals or deadly pathogenic agents are used to strike the population. Besides the nuclear attacks, biological or chemical agents most frequently cited are Anthrax (contaminated envelopes in the U.S. and Europe, 2001), smallpox, plague, cholera, tularaemia, botulism, Ebola virus, SARS or Sarin gas (Tokyo subway, 1995), cyanide (tea leaves from Sri Lanka, 1985), mercury (citrus fruit from Israel, 1970) soman, tabun, etc.

Pathogenic agents are classified according to the risk they present to health. Taken into account, in particular, are: their virulence, their infectious dose, their mode of transmission, host range, incubation and availability of preventive measures and treatments. Generally, four levels of risk are defined:

Risk Group 1: low risk for the individual and low for the community;

Risk Group 2: moderate risk for the individual, low for the community;

Risk Group 3: high risk for the individual, low for the community;

Risk Group 4: high risk for the individual, high for the community. It is the pathogenic agents of this group that are commonly cited for the bioterrorist attacks and for which no treatment or vaccine is available.

The handling of pathogenic agents should be conducted in analysis laboratories whose the level of containment is defined according to the level of risks identified above.

In France, the Order of 13 Aug. 1996 classifies the laboratories into four levels:

L1: basic laboratory for handling non-pathogenic agents (risk group 1);

L2: basic laboratory for handling weakly pathogenic agents (risk group 2);

L3: laboratory containment for handling of biological agents, highly pathogenic to the individual and weakly pathogenic at the community level (risk group 3);

L4: high-security containment laboratory for the handling of highly pathogenic to the individual and to the community (risk group 4).

In the case of an industrial accident or a terrorist attack, whatever the pathogenic agents in question, it is necessary to take emergency measures from the emergence of the first foci of infection. In particular, it is vital to rapidly diagnose the pathogenic agents under consideration in order that authorities can rapidly implement preventive measures and save lives.

Generally, a team of specialists takes samples (water, gas, debris, animals, removal of skin, . . .) on the contaminated area. These samples are next consideration then transported by a specialized vehicle to a hospital equipped with a L4-type analysis laboratory in order to maintain maximum security until the identification of the pathogenic agents. Once the diagnosis is made, information on the nature of risk is transmitted to the competent authorities, which take appropriate measures.

The specialized vehicles carrying the samples are best equipped with a level L3 biosafety enclosure; no diagnosis can be made even in the interior of the aforementioned vehicle. In addition, there are very few centers having a L4-type laboratory so that the time to transport samples from the contaminated area to the analysis laboratory can take several hours. This time lag passing between sampling and transmission of information on the nature of the risk to the competent authorities is thus not optimal, which is particularly detrimental with regard to the spread of pathogenic agents and the contamination of a growing number of individuals.

Laboratories including a mobile transportable container defining a basic chamber, are known from the documents WO 03/095765 (PETTUS) or 10.2004.026338 (KELLER), the interior space of the aforementioned chamber being partitioned from the exterior by a sealed caisson inserted in the aforementioned chamber, the aforementioned caisson including a sealed pathogenic agents analysis zone combined with a pressure device enabling maintenance of the interior of the aforementioned zone in negative pressure relative to its external environment. This type of laboratory enables performance, directly on the contaminated site, of a first analysis of pathogenic agents in order to transmit as soon as possible information on the risks involved. However, the design of this kind of mobile laboratory does not enable achievement of a L4 type level of security.

A primary object of the invention is therefore to offer a transportable mobile laboratory configured to enable handling of agents that are highly pathogenic for the individual and the community (L4-type laboratory).

When on manoeuvres, the military conventionally use mobile containers transported by vehicle to deliver technical equipment. A mobile transportable container defining a basic chamber and including at least one deployable wall to form an annex, is known from patent FR 2,821,869 (ALSTOM). This type of container is particularly advantageous because during its transport by vehicle, its floor space is limited to that of the basic chamber and when it is deployed on site, it offers a larger available space.

However, mobile transportable containers are not suitable for handling pathogenic agents, because they do not have adequate containment.

A second object of the invention is to adapt mobile transportable containers, and in particular of the type described in the patent FR 2,821,869 (ALSTOM) in order to safely carry out an initial analysis of pathogenic agents directly on the contaminated area.

Yet another goal of the invention is to offer a simple mobile laboratory design, rapidly operational on the contaminated area.

Another goal of the invention is to provide a radiological and/or biological and/or chemical mobile identification unit capable of operating independently on contaminated areas.

Another goal of the invention is to offer an autonomous radiological and/or biological and/or chemical identification assembly, easily transportable to all types of contaminated areas.

Thus, an object of the invention is a laboratory including a mobile transportable container defining a basic chamber, the interior space of the aforementioned chamber being partitioned from the exterior by means of a sealed caisson inserted in the aforementioned chamber, the aforementioned caisson including a sealed pathogenic agents analysis zone fitted with a pressure device enabling maintenance of the interior of the aforementioned zone in negative pressure relative to its external environment, the aforementioned laboratory being characterized that the sealed caisson includes:

a first protective equipment airlock,

a second sealed airlock communicating between the aforementioned sealed pathogenic agents analysis zone and the aforementioned first airlock,

a third sealed airlock communicating between the aforementioned sealed pathogenic agents analysis zone and the aforementioned first airlock, entry into the pathogenic agents analysis zone being made only by the aforementioned second airlock.

The claimed features enable perfect containment of the analysis zone, prevent pathogenic agents from freely exiting the latter, and enable realization of a high security L4-type laboratory.

According to a first implementation mode ensuring optimal safety, the third sealed airlock is the only airlock allowing exit from the sealed pathogenic agents analysis zone.

In an implementation variation to enabling optimization of the space available in the laboratory, the third sealed airlock is a double entry autoclave, the second sealed airlock being the only airlock allowing exit from the sealed pathogenic agents analysis zone.

According to an advantageous feature of the invention, the container includes at least a deployable wall forming an annex to the pathogenic agents analysis zone. In this way, it is possible to have a laboratory of approximately 30 m², which is sufficient space to work under good conditions.

According to a preferred implementation feature, the container includes two deployable side walls forming two annexes to the pathogenic agents analysis zone, the sealed caisson being arranged in the interior of the basic chamber of the aforementioned container. In this way, it is possible to have a laboratory offering a space enabling working under optimum conditions.

According to another advantageous feature of the invention, the second sealed airlock is fitted with a pressure device designed to maintain a positive pressure gradient between the aforementioned second airlock and the sealed pathogenic agents analysis zone (P_{second airlock}−P_{analysis zone}>0). Because of this pressure gradient, when personnel enter or leave the analysis zone via the second sealed airlock, the air circulates one-way towards the aforementioned analysis zone, which helps improve the retention of pathogenic agents.

According to yet another advantageous feature of the invention, the second sealed airlock is fitted with a pressure device designed to maintain a negative pressure gradient between the aforementioned second airlock and first protective equipment airlock (P_{first airlock}−P_{second airlock}>0). Because of this pressure gradient, when personnel enter the second sealed airlock via the first lock protective equipment airlock, the air circulates one-way towards the aforementioned second airlock, which helps improve the retention of pathogenic agents.

According to yet another advantageous feature of the invention, the third sealed airlock is fitted with a pressure device designed to maintain a negative pressure gradient between the aforementioned third airlock and the first protective equipment airlock (P_{first airlock}−P_{third airlock}>0). Because of this pressure gradient, when personnel leave the analysis via the third airlock, the air circulates one-way towards the aforementioned zone, which helps improve the retention of pathogenic agents.

According to yet another advantageous feature of the invention enabling optimization of the isolation of the laboratory, the sealed caisson is made of a molded piece having a hollow parallelepipedic shape without right angles and without parts inaccessible for cleaning. In an implementation variation, the sealed caisson is made of clean room panels attached between themselves according to the characteristics of L4-type laboratories, the connection between the lateral walls of the aforementioned caisson and the floor of the container being implemented by means of a sealed joint and a thermo-welded coating arranged in the interior of the aforementioned caisson.

According to yet another advantageous feature of the invention, a RT PCR analysis (Real Time Polymerase Chain Reaction) analysis device is positioned in the pathogenic agents analysis zone so that personnel can select and multiply a gene or a portion of identifiable chain of DNA or RNA in order to identify pathogenic agents most commonly encountered and diagnose the risk in less than two hours. A PCR (Polymerase Chain Reaction) analysis device is also provided for selecting and multiplying a gene or a portion of identifiable chain of DNA or RNA. This device enables identification of unknown pathogenic agents in less than seventy-two hours.

In another implementation variation, the sealed caisson includes a first sealed protective equipment airlock, a second sealed entry/exit airlock, a third sealed decontamination shower airlock fitted with a pressure device, the pathogenic agents analysis zone being accessible only by the aforementioned third airlock.

According to yet another preferred feature of the invention, the pressure device is combined with the pathogenic agents analysis zone is an air extractor combined with HEPA filters.

According to yet another preferred feature of the invention, the pathogenic agents analysis zone is equipped with a pressurized air supply adapted for working in a pressure suit.

According to yet another advantageous feature of the invention facilitating the deployment of the laboratory, gables panels and roof and floor panels are mounted to be moveable in the basic chamber local between a folded position where they are stored in the aforementioned basic chamber and a deployed position where they partition the annex. Preferentially the gabled panels are mounted pivoting around a vertical axis fastened on the structure of the basic chamber or on the lateral walls.

According to yet another preferred feature of the invention enabling the laboratory to be made rapidly operational, an external interface is arranged on a wall of the basic chamber, the aforementioned interface including means of connection to sources of electrical power, air and water.

Another aspect of the invention relates to a mobile radiological and/or biological and/or chemical identification unit including the combination of the mobile laboratory object of the invention equipped with the external interface defined above and an independent service module equipped with an electric generating unit, an air compressor and/or a vacuum pump and a water treatment device. The laboratory conforming to the invention can thus operate completely independently in the contaminated areas.

According to an advantageous feature of the invention enabling quick and easy coupling of the laboratory to the service module, without having to make complex couplings, the aforementioned service module includes an interface coupled to the electric generating unit, to the air compressor and/or to the vacuum pump and to the water treatment device and including means of connection designed to be coupled to the interface of the laboratory.

Still another aspect of the invention relates to an autonomous assembly for radiological and/or biological and/or chemical identification including the combination of a vehicle wherein the laboratory is arranged in accordance with invention.

Other advantages and features of the invention will better appear upon reading the description of a preferred implementation mode that follows, in reference to the attached drawings, made by way of guiding non-limiting examples, and in which:

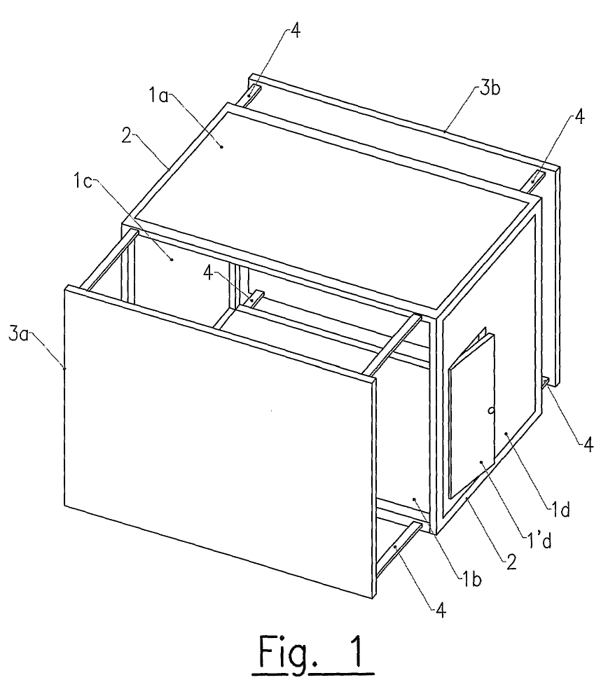

FIG. 1 is a perspective view of a deployable container,

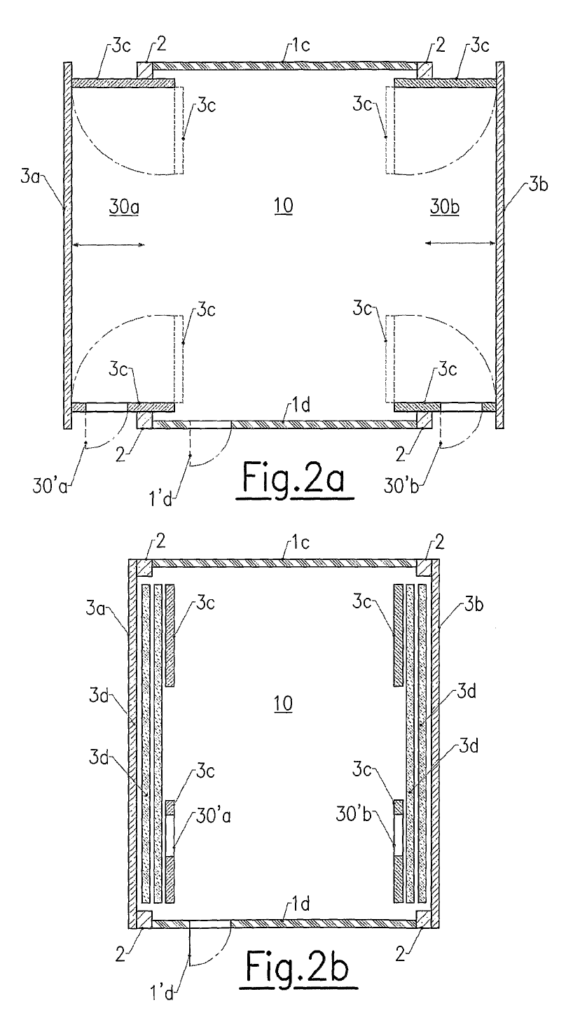

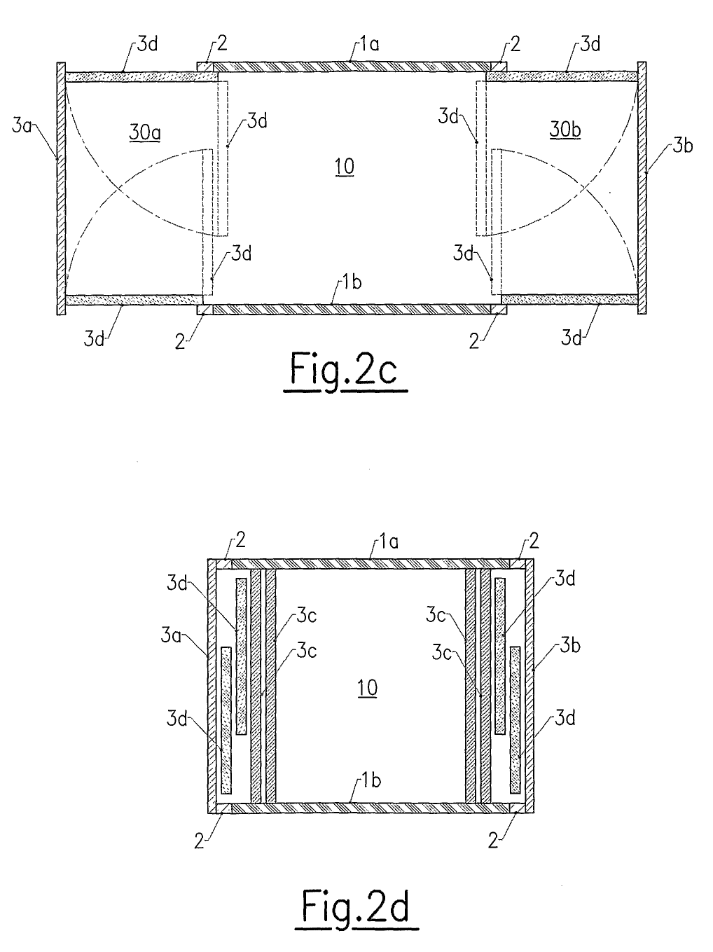

FIG. 2a is a schematic horizontal sectional view of the container of FIG. 1 in deployed position,

FIG. 2b is a schematic horizontal sectional view of the container of FIG. 1 in folded position,

FIG. 2c is a schematic vertical sectional view of the container of FIG. 1 in deployed position,

FIG. 2d is a schematic vertical sectional view of the container of FIG. 1 in folded position,

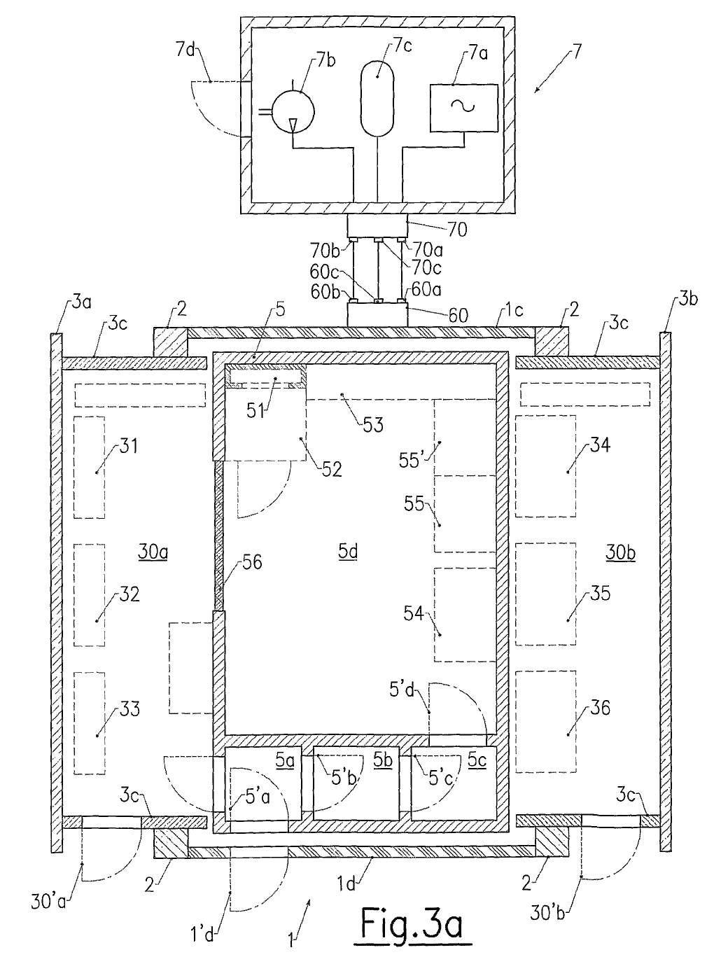

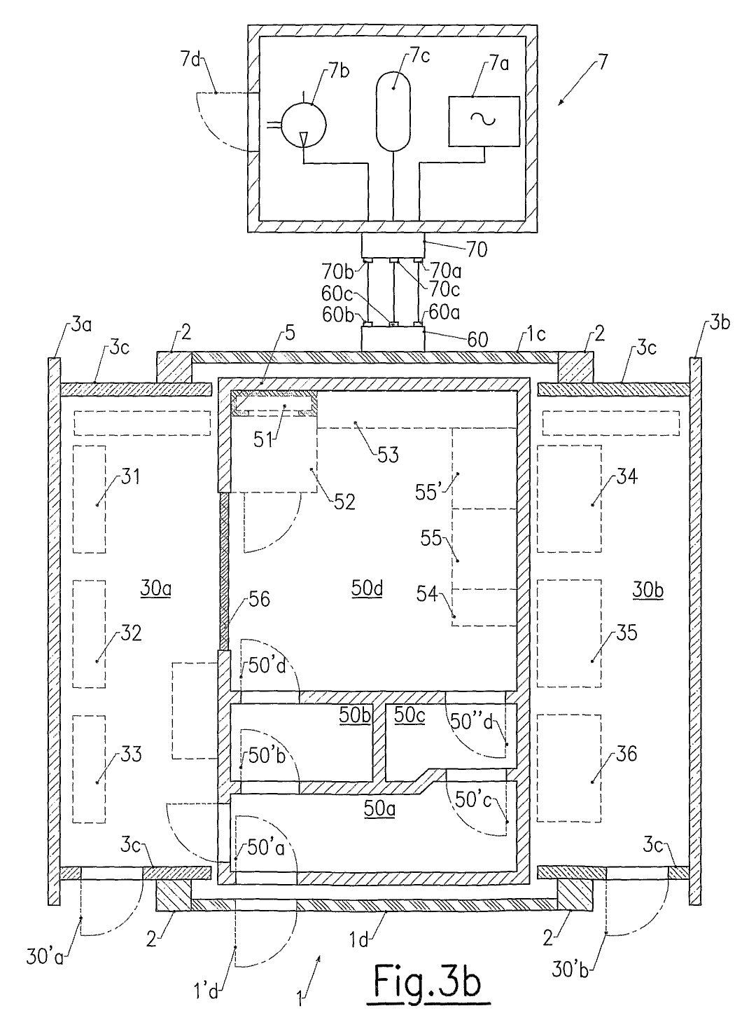

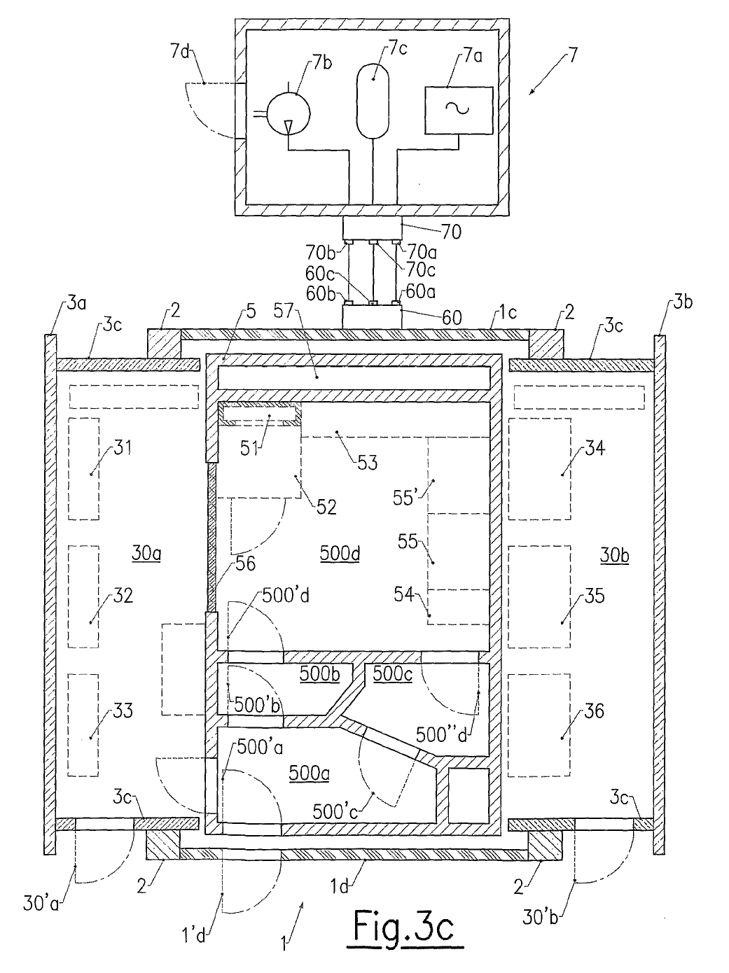

FIG. 3a is a schematic horizontal sectional view section of the laboratory object of the invention in deployed position combined with its service module,

FIG. 3b is a schematic horizontal sectional view of the laboratory object of the invention in deployed position and combined with its service module, in an implementation variation,

FIG. 3c is a schematic horizontal sectional view of the laboratory object of the invention in deployed position and combined with its service module, in another implementation variation,

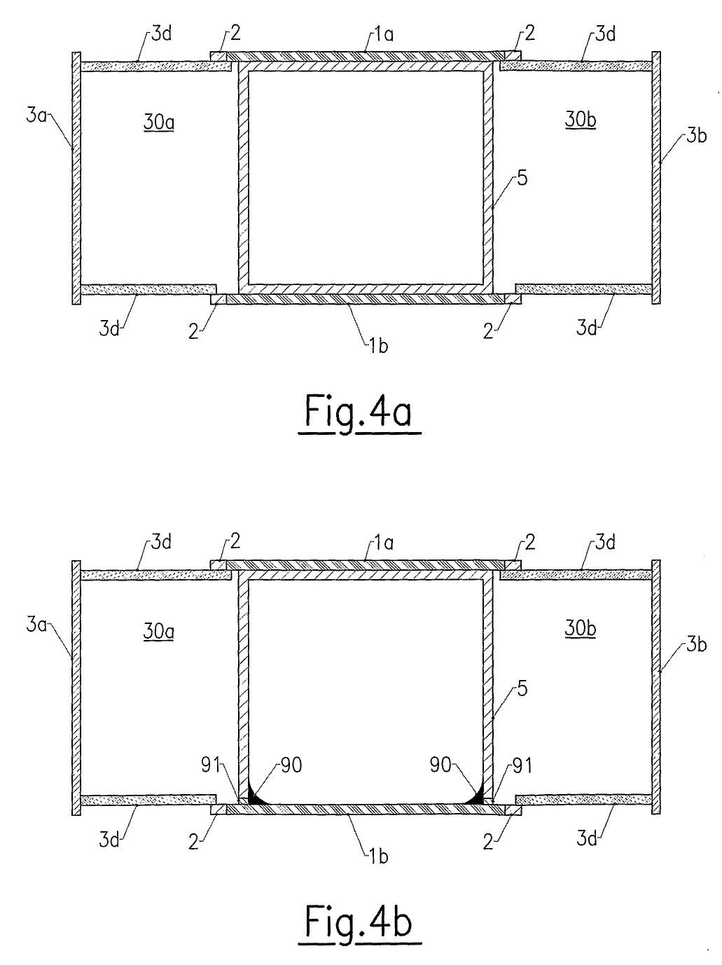

FIG. 4a is a schematic vertical sectional view of the container in deployed position showing the layout of the sealed caisson,

FIG. 4b is a schematic vertical sectional view of the container in the deployed position showing the layout of the sealed caisson in an implementation variation,

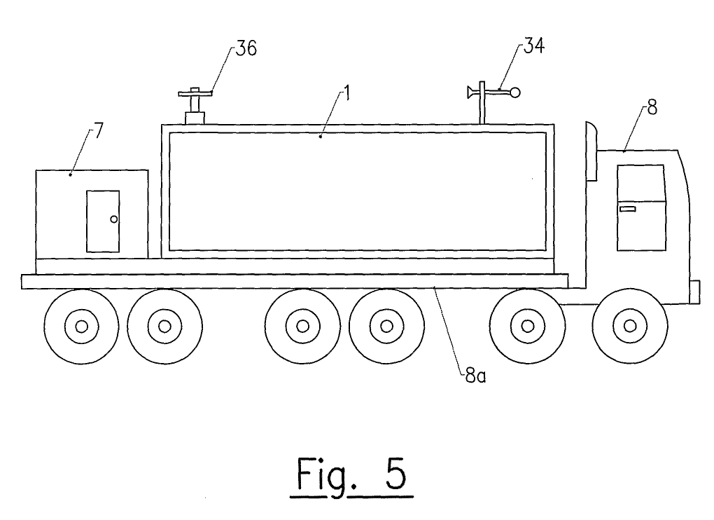

FIG. 5 is a schematic view of the entire mobile object of the invention.

The laboratory object of the invention is designed for intervening rapidly in areas contaminated by biological, chemical, or radioactive agents, that are either as part of a terrorist attack or an industrial accident, and to effectuate directly on the contaminated area a first analysis of the pathogenic agents to in order to inform, in real-time, competent authorities in order to make decisions rapidly that are imposed regarding the emergency medical and decontamination measure to put in place. The removed samples will then be transported to specialized laboratories that will subsequently carry out a comprehensive and detailed analysis.

To implement the outer structure of the laboratory object of the invention, a mobile transportable container is used, i.e. a container normally used for transporting materials or goods and adapted to be temporarily or permanent by fastened to the trailer of a truck.

Referring to FIG. 1, a 20-foot parallelepipedic container is used, formed from a roof 1a, a floor 1b, a rear wall 1c and front wall 1d equipped with a door 1′d. These four elements are fastened between themselves, possibly by means of a frame 2 and delineate a basic chamber 10 with a fixed space (FIGS. 2a to 2d).

Referring to FIGS. 1, 2a, 2b, 2c and 2d, two walls 3a and 3b are deployably mounted to form two extensions 30a and 30b to the basic chamber 10. When the walls 3a and 3b are in folded position (FIG. 2b), the floor space of the container congestion is limited to the floor space of the basic chamber 10. When the walls 3a and 3b are in deployed position (FIG. 2a), the floor space of the container is increased by the floor space of the two annexes 30a and 3b for a total usable area of approximately 30 m. The two annexes 30a and 30b are accessible by doors 30′a and 30′b.

According to a preferred implementation mode shown in FIG. 1, the two lateral walls 3a and 3b of the basic chamber 10 are mounted to be translationally movable by guiding means 4. The guiding means employed can be guiding bars fastened on the walls 3a and 3b and sliding in the tracks positioned at the level of roof 1a and/or of the floor 1b. Any other equivalent means of guidance can be used.

The deployment of the walls 3a and 3b can be effectuated manually, but the guiding means 4 are optimally coupled to a conventional motorization.

Referring to the figures attached, once the walls 3a and 3b are in deployed position, means of closing are provided to partition the annexes 30a and 30b.

Referring more particularly to FIGS. 2a and 2b, to partition the front and back walls of annexes 30a and 30b, preferably gabled panels 3c are used, mounted to be moveable in the basic chamber 10, between a folded position where they are packed in the aforementioned basic chamber (FIG. 2a) and a deployed position where they partition the aforementioned annexes when the walls 3a and 3b are themselves deployed (FIG. 2b). According to a preferred implementation example, the gabled panels 3c are mounted pivoting around a vertical axis fastened on the structure of the basic chamber 10 or on the structure of walls 3a and 3b.

Referring more particularly to FIGS. 2c and 2d, to close the roof and floor of annexes 30a and 30b, preferably roof and floor panels 3d are used, mounted to be moveable in the basic chamber 10 between a folded position where they are packed in the aforementioned basic chamber (FIG. 2c) and a deployed position where they partition the aforementioned annexes when the walls 3a and 3b are themselves deployed (FIG. 2c). According to a preferred implementation example, roof and floor panels 3d are mounted pivoting around a horizontal axis fastened on the structure of the basic chamber 10 or on the structure of walls 3a and 3b.

The deployment of the container is then effected very quickly: after having deployed the two walls 3a and 3b, it is sufficient to rotate, around their respective axis, first roof and floor panels 3d, then gabled panels 3c, a device that temporarily maintains the various panels in position being provided.

In an implementation variation not shown, the closing means enabling partition of the annexes 30a and 30b are waterproof sheetings attached to the structure of the basic chamber 10 and to the structure of walls 3a and 3b so that the aforementioned sheetings will automatically be put in place when the aforementioned walls are deployed.

Referring to FIGS. 3a and 3b, the interior space of the basic chamber 10 is isolated from the exterior by means of a sealed caisson 5 inserted in the aforementioned chamber. Referring to FIG. 4a, the caisson 5 is optimally made of a molded piece in the shape of a hollow parallelepipedic without right angles and without parts inaccessible for cleaning. In an implementation variation shown in FIG. 4b, the caisson 5 is made of clean room panels attached between themselves according to the characteristics of the L4 type laboratories, the connection between the lateral walls of the aforementioned cabinet and the floor 1b of the container being made by means of a sealed joint 91 and a thermo-welded coating 90 arranged inside the aforementioned caisson. In another implementation variation, it is the movable walls of the transportable container that are attached between themselves according to the characteristics of the L4 type laboratories.

The caisson 5 includes a pathogenic agents analysis zone 5d, 50d, 500d, approximately 9 m², fitted with a pressure device enabling maintenance of the interior of the aforementioned zone in negative pressure relative to the external environment. An alarm system is provided to detect any unacceptable change of pressure.

By “pressure device”, within the meaning of the present invention, it is meant a device capable of regulating the pressure of a room (positive or negative pressure) according to a given set point.

The pressure device used in the analysis zone of pathogenic agents 5d, 50d, 500d, is preferentially an air extractor combined with HEPA filters. An exhaust fan coupled to an emergency fan is used, for example. Any other equivalent pressure device can be used.

Because of the pressure gradient existing between the external environment and the analysis zone 5d, 50d, 500d, no airborne pathogenic agents can freely exit the aforementioned zone.

The air entering the analysis zone 5d, 50d, 500d, is air-conditioned and treated by passing through HEPA filters mounted in series with prefilters.

A decontamination device for the effluents extracted from the aforementioned caisson is provided to prevent release of pathogenic agents into the external environment. Heat and/or chemical agents of the Sanytex® type are used as means of action for the treatment of wastewater and biologic fluids. Solid wastes (consumables, pipettes, culture medium, protective clothing, . . .) are decontaminated by autoclaves or incinerators.

A FM200® type system for automatic detection and extinguishing of fire by gas is provided in the pathogenic agents analysis zone 5d, 50d, 500d. Detection is effected by smoke and temperature sensors in the ceiling of the entire pathogenic agents analysis zone 5d, 50d, 500d. Manually operated emergency extinguishers are also easily accessible to personnel.

The caisson 5 is also equipped with an approximately 2 m³ reserve of hot and cold water combined with a water booster pump.

According to a first implementation mode shown in FIG. 3a, the caisson 5 optimally includes:

a first protective equipment airlock 5a where personnel dress in protective clothing constituted by coveralls and a pressure suit. The first airlock is accessible from the exterior through a sealed door 5′a equipped with a controlled badge-type closure system. A pictogram is provided on the door 5′a to indicate the biohazard. The first protective airlock 5a is preferentially fitted with a pressure device designed to maintain a positive pressure gradient between the external environment and the aforementioned airlock (Pₑₓₜₑᵣᵢₒᵣ−P_{first airlock}>0). In a preferred implementation mode, the first protective airlock 5a is maintained at a negative pressure between −10 Pa and −20 Pa.

a second sealed entry/exit airlock 5b serving as a transition between the first protective equipment airlock 5a and the third decontamination shower airlock 5c. This second airlock 5b is accessible from the first airlock 5a via a sealed door 5′b equipped with a controlled badge-type closure system. The second entrance/exit airlock 5b is preferentially fitted with a pressure device designed to maintain a positive pressure gradient between the first airlock 5a and the aforementioned second airlock (P_{first airlock}−P_{second airlock}>0). Preferably, the second airlock 5b is maintained at a negative pressure between −10 Pa and −20 Pa.

a third sealed airlock 5c, only access to the analysis zone 5d. This third airlock is accessible from the second airlock 5a via a sealed door 5′c equipped with a badge-type regulated locking system. The third airlock 5c is fitted with a pressure device to maintain a positive pressure gradient between the aforementioned third airlock 5c and the analysis zone 5d (P_{third airlock}−P_{analysis zone}>0). Because of this positive pressure gradient, pathogenic agents handled in the analysis zone 5d and airborne cannot exit freely via the third airlock 5c. The pressure device is the type known to the person of skill in the art.

the pathogenic agents analysis zone 5d accessible only by a sealed door 5′d equipped with a badge-type regulated locking system.

Optimally, the analysis zone 5d is maintained at a pressure between −20 Pa and −80 Pa, preferably −60 Pa and the third airlock 5c is maintained at a pressure of between −10 Pa and −30 Pa, preferably −20 Pa. In an implementation variation, the third airlock 5c is maintained at a pressure between 20 Pa and 80 Pa, preferably 60 Pa.

According to a second implementation mode shown in FIG. 3b, the caisson 5 optimally includes

a first protective equipment airlock 50a in which personnel dress in protective clothing constituted by coveralls and a pressure suit. This first airlock is accessible from the exterior through a sealed door 50′a equipped with a badge-type regulated locking system. A pictogram is provided on the door 50′a to indicate the biohazard. The first protective airlock 50a is preferentially fitted with a pressure device designed to maintain a positive pressure gradient between the external environment and the airlock (Pₑₓₜₑᵣᵢₒᵣ−P_{first airlock}>0). In a preferred implementation mode, the first protective airlock 50a is maintained at a negative pressure between −10 Pa and −20 Pa.

a second sealed entry airlock 50b, only access to the analysis zone 50d. This second lock is accessible from the first airlock 50a by a sealed door 50′b equipped with a badge-type regulated locking system. The second airlock 50b is fitted with a pressure device designed to maintain a positive pressure gradient between the aforementioned second airlock 50b and the analysis zone 50d (P_{second airlock}−P_{analysis zone}>0) and optimally between the first airlock 50a and the aforementioned second airlock (P_{second airlock}−P_{analysis zone}>0). Because of this positive pressure gradient pathogenic agents handled in the analysis zone 50d and airborne cannot exit freely via the second airlock. The pressure device is the type known to the person of skill in the art. Optimally, the second airlock 50b is maintained at a pressure of between −10 Pa and −30 Pa, preferably −20 Pa. In an implementation variation, the second airlock 50b is maintained at a pressure between +20 and +80 Pa, preferably +60 Pa.

the pathogenic agents analysis zone 50d accessible only by a sealed door 50′d equipped with a watertight badge-type regulated locking system. Optimally, the analysis zone 50d is maintained at a pressure between −20 Pa and −80 Pa, preferably −60 Pa.

a third sealed exit airlock 50c, only exit from the analysis zone 50d. This third airlock is accessible from the analysis zone 50d via a sealed door 50″d equipped with a badge-type regulated locking system and communicates with the first protective airlock 50a. The third airlock 50c is fitted with a pressure device designed to maintain a positive pressure gradient between the third aforementioned airlock 50c and the analysis zone 50d (P_{third airlock}−P_{analysis zone}>0) and optimally between the first airlock 50a and the aforementioned third airlock (P_{first airlock}−P_{second airlock}>0). Because of this positive pressure gradient, pathogenic agents handled in the analysis zone and 50d and airborne cannot exit freely via the third airlock. The pressure device is the type known to a person of skill in the art. Optimally, the third airlock 50c is maintained at a pressure of between −10 Pa and −30 Pa, preferably −20 Pa. In an implementation variation, the third lock 50c is maintained at a pressure between +20 Pa and +80 Pa, preferably +60 Pa.

According to a third implementation mode shown in FIG. 3c, the caisson 5 optimally includes:

a first protective equipment airlock 500a in which personnel dress in protective clothing constituted by coveralls and a pressure suit. This first airlock is accessible from the exterior via a sealed door 500′a equipped with a badge-type regulated locking system. A pictogram is provided on the door 500′a to indicate the biohazard. An equipment room 58 can be laid out in the first airlock 500a. The first protective airlock 500a is preferentially fitted with a pressure device designed to maintain a positive pressure gradient between the external environment and the aforementioned airlock (Pₑₓₜₑᵣᵢₒᵣ−P_{first airlock}>0). In practice, the pressure prevailing in the first airlock 500a is approximately +300 Pa.

a second sealed airlock 500B, only means of entry into the analysis zone 500d. This second airlock is accessible from the first airlock 500a via a sealed door 500′b equipped with a badge-type regulated locking system. The second airlock 500b is preferentially fitted with a pressure device designed to maintain a positive pressure gradient between the aforementioned second airlock 500b and the analysis zone 500d (P_{second airlock}−P_{analysis zone}>0) and optimally between the first airlock 500a and the aforementioned second airlock (P_{first airlock}−P_{second airlock}>0). Because of this positive pressure gradient, pathogenic agents handled in the analysis zone 500d and airborne cannot exit freely via the second airlock when personnel enter or leave it. The pressure device is the type known to a person of skill in the art. Optimally, the second airlock 500b is maintained at a pressure of approximately −300 Pa. In an implementation variation, the second airlock 500b is kept at a pressure of approximately +300 Pa. The second airlock 500b is optimally equipped with an automatic decontamination shower as described below.

the pathogenic agents analysis zone 500d accessible only by a sealed door 500′d equipped with a badge-type regulated locking system. Optimally, the analysis zone 500d is maintained at a pressure of approximately −300 Pa.

a third sealed airlock 500c accessible from the analysis zone 500d by a sealed door 500″d equipped with a badge-type regulated locking system. This third airlock communicates with the first protective airlock 500a. The third airlock 500c is optimally fitted with a pressure device designed to maintain a positive pressure gradient between the aforementioned third airlock 500c and the analysis zone 500d (P_{third airlock}−P_{analysis zone}>0) and optimally between the first and the first airlock 500a and the aforementioned third airlock (P_{first airlock}−P_{second airlock}>0). Because of this positive pressure gradient pathogenic agents handled in the analysis zone 500d and airborne cannot exit freely by the aforementioned third airlock when personnel enter or leave it. The pressure is the type known to a person of skill in the art. Optimally, the third airlock 500c is maintained at a pressure of approximately −300 Pa. In an implementation variation, it can be maintained at a pressure of approximately 300 Pa. Depending on the situation, the third airlock can be:

o either the only airlock allowing exit from the analysis zone 500d,

o or a double entry autoclave, i.e. accessible from the analysis zone 500d or accessible from the first equipment gate 500a. In this case, the second airlock 500b is the only airlock allowing exit from the analysis zone 500d.

According to an advantageous feature of the invention, when the laboratory is implemented according to the third implementation mode shown in FIG. 3c, the various airlocks are equipped with a pressure device enabling balancing of the pressure from one airlock to the other. This feature facilitates the opening of different doors. The balance of pressure is made relative to the pressure prevailing in the airlock where the person is and the pressure prevailing in the room where that person wants to go.

The third sealed airlock 5c, 50c, 500c is optimally equipped with a shower to decontaminate personnel when they exit the pathogenic agents analysis zone 5d, 50d, 500d. Once personnel exit from the pathogenic agents analysis zone 5d, 50d, 500d and enters the third airlock 5c, 50c, 500c, it recloses the door 5′d, 50″d, 500″d and decontamination shower is automatically placed in operation for approximately 4 minutes to spray the personnel with a chlorine-based decontamination solution. The decontamination shower is followed by a 2 minutes rinse shower.

According to the first implementation mode shown in FIG. 3a, upon exiting the shower, personnel enter the second sealed airlock 5b, remove their protective clothing and burn it by means of an incinerator provided for that purpose. An autoclave can also be used in an equivalent manner. When the personnel leaves the third airlock 5c to renter into the pathogenic agents analysis zone 5d, the shower can be automatically placed in operation for one minute when the door 5′d is reclosed. This decontamination enables assurance of the decontamination of the air that has entered the third airlock 5c.

According to the second and third implementation modes shown respectively in FIGS. 3b and 3c, upon exiting the shower of the third airlock 50c, 500c, personnel enter the first protective equipment airlock 50a, 500a via a sealed door 50′c, 500′c, removes their protective clothing and burn it by means of an incinerator provided for this purpose. An autoclave can also be used in an equivalent manner.

In the case where the second sealed airlock 500d is the only exit from the analysis zone 500d (implementation mode of FIG. 3c), the aforementioned second airlock is optimally equipped with a shower, to decontaminate personnel, of the type described above. Once the personal exit the pathogenic agents analysis zone 500d and enter the second airlock 500b, they reclose the door 500′d and the decontamination shower is automatically placed in operation for approximately 4 minutes followed by a 2 minutes rinse shower. Upon exiting the shower, the personnel enter the first protective equipment airlock 500a via the sealed door 500′b, removes their protective clothing and burn it using an incinerator provided for this purpose. An autoclave can also be used in an equivalent manner.

The pathogenic agents analysis zone 5d, 50d, 500d is equipped with a pressurized air supply adapted for working in a pressure suit. It relates in this case to a level L4 microbiological security laboratory “pressure suit”. When personnel are plugged into the supply, all protective clothing is in positive pressure relative to the pathogenic agents analysis zone 5d, 50d, 500d so that in case of accidental tear, the air exits from the aforementioned clothing and prevents the pathogenic agents from re-entering in contact with the individual. The pressurized air supply for working in a pressure suit is implemented with a compressor provided for this purpose, but the rescue bottles of pressurized breathable air are provided in the pathogenic agents analysis zone 5d, 50d, 500d.

Personnel located outside the pathogenic agents analysis zone 5d, 50d, 500d, is constantly in communication with personnel located inside the aforementioned zone via microphones positioned in the pressure suits and activated by voice and that leave the hands free. Other equivalent means of communication can be used, such as intercoms, telephone, satellite phone jacks, fax, computer network, and etc.

These communication means are preferentially coupled to telediagnostic and/or data retransmission and/or video imagery means to transmit information to the competent authorities as rapidly as possible. Optimally, the data transmission is performed in real time by a satellite system to enable a rapid decision by the authorities.

An observation window 56 is arranged on one of the walls of the caisson 5 so that personnel located in the annex 30a can permanently monitor personnel located in the pathogenic agents analysis zone 5d, 50d, 500d and take any necessary measures in case of incidents. An equivalent video system can also be used.

In case of accident, emergency personnel can break the observation window 56 to intervene rapidly in the pathogenic agents analysis zone 5d, 50d, 500d. The observation window 56 is the sealed type, resistant to high pressure gradients. An inflatable joint, including a membrane in which pressurized air is injected, is arranged around the window 56 to from sealing.

The withdrawal of the observation window 56 when setting up the laboratory object of the invention enables entry (and exit) of the material used in the pathogenic agents analysis zone 5d, 50d, 500d.

Referring to FIGS. 3a and 3b, the pathogenic agents analysis zone 5d, 50d, 500d is equipped with a glove box 51 accessible via a sealed transfer airlock 52. The glove box 51 is coupled to a microbiological security post 53 with a laminar flow hood (type III).

A lab bench 54 is equipped with a CO₂ incubator, a microscope, a refrigerator, a double entry autoclave, sinks with faucets operated without hands, a water bath and small basic materials (vortex, automatic pipettes, . . .).

A single or double entry autoclave can be positioned directly in the analysis zone 5d, 50d, 500d. However, referring to the implementation mode shown in FIG. 3c, when the third airlock 500c is used as double entry autoclave, the space saved in the analysis zone 500d enables provision of a duct 57 in which will be positioned the ventilation systems and/or pressure devices.

A RT PCR (Real Time Polymerase Chain Reaction) device 55 is also provided for selecting and multiplying a gene or a portion of identifiable chain of DNA or RNA. This device enables identification of the most frequent pathogenic agents in less than two hours.

A PCR (Polymerase Chain Reaction) device 55′ is also provided for selecting and multiplying a gene or a portion of identifiable chain of DNA or RNA. This device enables identification of unknown pathogenic agents in less than seventy-two hours.

The annexes 30a and 30b include radiological and chemical means of detection: flame photometry detectors 31, fixed or mobile mass spectrometer 32, biological and/or chemical and/or radiological risk detection devices 33, weather station 34 coupled to computer programs for data processing, to enable calculation and prediction of the spread of areas contaminated by chemical agents, a radiation meter 35, a detector of toxic warfare chemicals 36, etc.

According to an optimal implementation mode, annexes 30a and 30b are fitted with a pressure device designed to maintain a positive pressure gradient between the external environment and the aforementioned annexes (Pₑₓₜₑᵣᵢₒᵣ−Pₐₙₙₑₓ>0). Preferably, the annexes 30a and 30b are maintained at a negative pressure between −10 Pa and −20 Pa.

Referring to FIGS. 3a and 3b, an independent service module 7 provides electric power, water and air to the laboratory 1 object of the invention.

The combination of the laboratory module 1 and the service module 7 constitutes a mobile radiological and/or biological and/or chemical identification unit, functioning in a completely autonomous manner, and can easily be deployed on the contaminated area.

The service module 7 is a mobile container equipped with an electric generating unit 7a, an air compressor and/or a vacuum pump 7b and a device for water treatment 7c by reverse osmosis. Although an emergency supply electrical power system is integrated into the laboratory 1, preferentially a second electric generating unit and a second air compressor are provided in the service module 7.

Access to the service module 7 is made by a sealed door 7d equipped with a badge-type regulated locking system.

An external interface 60 is arranged on the wall of the basic chamber of the laboratory 1 so as to be able to quickly connect it to the service module 7. The interface 60 includes means of connection 60a, 60b, 60c to the electric generating unit 7a, to the air compressor and/or to the vacuum pump device 7b and to the water treatment device 7c, of the rapid coupling type known to a person of skill in the art.

Similarly, the service module 7 includes an interface 70 coupled to the electric generating unit 7a, to the air compressor and/or to the vacuum pump 7b and to the water treatment device 7c, and including means of connection 70a, 70b, 70c designed to be coupled respectively to the connection means 60a, 60b, 60c of the interface 60 of the laboratory object of the invention.

The connection between the service module 7 and the laboratory 1 is thus made very rapidly by simply connecting the different means of connection of the interfaces 60 and 70, for example by using quick couplings for the plugging in of water and air pipes and jacks for plugging in electrical cables.

The laboratory 1 object of the invention is addressed to emergency workers, army, civil protection, fire fighters, and, more particularly, to defense sectors, security, health surveillance in the case of epidemiological studies, and the chemical and oil industry.

It enables for example identification of toxic warfare or industrial chemicals by mass spectrometry and NIST database, to determine areas of danger to the population using the integrated weather station and computer programs for data processing, to identify in less than two hours, by PCR method, pathogenic germs potentially usable by bioterrorists or carry out epidemiological studies on site of viruses that can cause pandemics.

Referring to FIG. 4, the laboratory 1 object of the invention and the service module 7 are harnessed to be transported in a 4×4 type vehicle 8. The laboratory 1 and the service module 7 are mounted in a removable manner or fastened manner on a trailer 8a of the vehicle 8.

In an implementation variation, the vehicle 8 includes a cell in which is adapted the laboratory object of the invention in a fixed manner. This laboratory can also include a contained zone equipped with a half pressure-suit for handling highly pathogenic L4 class germs.

This combination constitutes an autonomous assembly for radiological and/or biological and/or chemical identification that can rapidly reach any kind of contaminated area.

A mobile robot deployed from the vehicle can, via a system of remote control, perform removal of samples, or transport chemical or radiological sensors at a distance of 2 to 3 km.

1. A laboratory including a mobile transportable container defining a basic chamber, the interior space of the aforementioned chamber being partitioned from the exterior by means of a sealed caisson inserted in the aforementioned chamber, the aforementioned caisson including a sealed pathogenic agents analysis zone fitted with a pressure device enabling maintenance of the interior of the aforementioned zone in negative pressure relative to its external environment, characterized by the fact that the sealed caisson includes:
a first protective equipment airlock,
a second sealed airlock communicating between the aforementioned sealed pathogenic agents analysis zone and the aforementioned first airlock,
a third sealed airlock communicating between the aforementioned sealed pathogenic agents analysis zone and the aforementioned first airlock, entry into the pathogenic agents analysis zone being made only by the aforementioned second airlock.

2. A laboratory according to claim 1, characterized by the fact that the third sealed airlock is the only airlock allowing exit from the sealed pathogenic agents analysis zone.

3. A laboratory according to claim 1, characterized by the fact that the third sealed airlock is a double entry autoclave, the second sealed airlock being the only airlock allowing exit from the sealed pathogenic agents analysis zone.

4. A laboratory according to claim 1, characterized by the fact that the container includes a deployable wall forming an annex to the pathogenic agents analysis zone.

5. A laboratory of claim 4, characterized by the fact that the container includes two deployable lateral walls forming two annexes to the pathogenic agents analysis zone, the sealed caisson being arranged in the interior of the basic chamber of the aforementioned container.

6. A laboratory according to claim 1, characterized by the fact that the second sealed airlock is fitted with a pressure device designed to maintain a positive pressure gradient between the aforementioned second airlock and the sealed pathogenic agents analysis zone.

7. A laboratory according to claim 1, characterized by the fact that the second sealed airlock is fitted with a pressure device designed to maintain a negative pressure gradient between the aforementioned second airlock and the first protective equipment airlock.

8. A laboratory according to claim 1, characterized by the fact that the third sealed airlock is fitted with a pressure device designed to maintain a negative pressure gradient between the aforementioned third airlock and the first protective equipment airlock.

9. A laboratory according to claim 1, characterized by the fact that the sealed caisson is made of a molded piece having a hollow parallelepipedic shape without right angles and without parts inaccessible for cleaning.

10. A laboratory according to claim 1, characterized by the fact that the sealed caisson is made of clean room panels attached between themselves according to the characteristics of L4-type laboratories, the connection between the lateral walls of the aforementioned caisson and the floor of the container being implemented by means of a sealed joint and a thermo-welded coating arranged in the interior of the aforementioned caisson.

11. A laboratory according to claim 1, characterized by the fact that the pathogenic agents analysis zone is equipped with a pressurized air supply adapted for working in a pressure suit.

12. A laboratory according to claim 1, characterized by the fact that a RT PCR and/or PCR analysis device is positioned in the pathogenic agents analysis zone.

13. A laboratory according to claim 1, characterized by the fact that an external interface is arranged on a wall of the basic chamber, the aforementioned interface including means of connection to sources of electrical power, air and water.

14. A mobile radiological and/or biological and/or chemical identification unit characterized by the fact that it includes the combination of the laboratory according to claim 13 and an independent service module equipped with an electric generating unit, an air compressor and/or a vacuum pump and a water treatment device.

15. A mobile unit according to claim 14, characterized by the fact that the service module includes an interface coupled to the electric generating unit, to the air compressor and/or to the vacuum pump, and to the water treatment device and including means of connection designed to be coupled to the interface of the laboratory.

16. An autonomous assembly for radiological and/or biological and/or chemical identification characterized by the fact that it includes the combination of a vehicle with the laboratory in accordance with claim 1.
